(19) United States
(12) Patent Application Publication
(10) Pub. No.: US 2005/0241106 A1
(43) Pub. Date: Nov. 3, 2005

(54) Adjustable gate hinge having stamped metal pivot components

(76) Inventors: Saul S. Sosa, Spanish Fork, UT (US); Jared W. Sheetz, Orem, UT (US)

Correspondence Address: Angus C. Fox, III, 4093 N. Imperial Way, Provo, UT, 84604-5386, US

(21) Appl. No.: 11/175,467

(22) Filed: Jul. 5, 2005

Related U.S. Application Data
(62) Division of application No. 10/298,346, filed on Nov. 18, 2002.

(51) Int. Cl. E05F 1/08

(52) U.S. Cl. 16/278

(57) ABSTRACT

An adjustable gate hinge assembly is fabricated from stamped components and includes a base plate mountable to a gate or door, an inner hinge component slidably adjustable and securable to the base plate with threaded fasteners, an outer hinge component mountable to a fence or wall, first and second pivot plugs which locate the inner hinge component within the outer hinge component, and a rivet which passes through the slot of each pivot plug, thereby retaining them seated within the outer hinge component. The inner hinge component has a tubular member which pivots between a pair of opposed drawn ears on the outer hinge component. Each of the ears has an aperture that is axially aligned with the aperture of the other ear. For a preferred embodiment of the invention, the hinge assembly incorporates a coil spring within the tubular member, which can be loaded to bias the hinge as self-closing or self-opening.

This is a divisional of patent application Ser. No. 10/298,346, which was filed on Nov. 18, 2002, and is now abandoned.

### BACKGROUND OF THE INVENTION

1. Field of the Invention

This invention broadly relates to hinges for use with gates or other swinging structures. More particularly, the invention relates to adjustable gate hinges fabricated from stamped metal components.

2. Description of Related Art

Gates, and in particular gates used with fencing to provide access to a field or enclosure are well-known, it being typically desired to have the gate level to preserve the swinging function of the gate (e.g., avoid dragging the gate on the ground) and to present a pleasing appearance. Upper and lower hinges are used to support the gate while it swings between a closed position in general alignment with the fence and an open position to permit access through the gate. Most modern hinges incorporate a high degree of adjustability so that the gate, to which the hinges are attached, may be positioned in a level attitude.

The gate hinges disclosed in U.S. Design Pat. No. D396,626 to D. Francom and U.S. Pat. No. D443,196 to S. Sosa are representative of gate hinges which are presently being sold in this country. The large majority of such hinges are used in connection with vinyl fencing. Referring now to FIG. 1, this isometric view of the hinge assembly 100 of U.S. Pat. No. D443,196 shows the significant features of this genre of gate hinge. The hinge assembly 100 includes a first sheet metal stamping 101 having a pair of horizontally-oriented ears 102 with axially and vertically-aligned apertures (not shown in this view), a second metal stamping 103 having a pair of vertically-oriented ears 104 with axially and horizontally-aligned apertures (not shown in this view), a first tubular member 105, to which is welded a threaded rod 106, a pivot pin 107, which passes through the vertically-aligned apertures, thereby securing the first tubular member 105 to the horizontally-oriented ears, a second tubular member 108, which acts as a spacer between the pair of vertically-oriented ears, and a pair of nuts 109, which are used to lock the threaded rod 106 in a desired position within the apertures of the pair of vertically-oriented ears 104. It will be noted that both the horizontally-oriented ears 102 and the vertically-oriented ears 104 of hinge assembly 100 have been formed by simultaneously punching and bending the backing plate. Because each of the ears 102 and 104 is cantilevered and unbraced, they may be bent if a downward force is applied to the gate, to which the hinges are attached. It will also be noted that fabrication of the hinge assembly 100 requires that the threaded rod 106 be bead welded to the first tubular member. Such a welding operation requires either skilled welders or sophisticated robotics equipment. It will be further noted that both the pivot pin 107 and the threaded rod 106 are major components of the hinge assembly 100 which must be fabricated by machining, rather than stamping. As a general rule, machining operations are significantly more expensive and significantly slower than progressive, high-speed sheet metal stamping operations. The requirement for machined and bead-welded components in the hinge assembly 100 raises the production cost thereof.

What is needed is a new type of gate hinge, which has no cantilevered stamped components, which requires no bead welding, and for which the only machined components are a pair of standard bolts.

### SUMMARY OF THE INVENTION

The present invention provides a new gate hinge assembly that is both stronger and less expensive to manufacture than those which in current production and use. In its most basic form, the new gate hinge assembly includes a base plate mountable to a gate or door, an inner hinge component slidably adjustable and securable to the base plate with threaded fasteners, an outer hinge component mountable to a fence or wall, first and second pivot plugs which locate the inner hinge component within the outer hinge component, and a rivet which passes through a central aperture of each pivot plug, thereby retaining them seated within the outer hinge component. The inner hinge component has a tubular member which pivots between a pair of opposed drawn ears on the outer hinge component. Each of the ears has an aperture that is axially aligned with the aperture of the other ear. For a preferred embodiment of the invention, the inner hinge component is equipped with a slot which receives the outwardly-bent first end of a coil spring, which fits within the tubular member of the inner hinge component. The opposite second end of the coil spring is bent so that it is parallel to the central axis of the spring. The second end fits within a spring retention aperture within the second pivot plug. An outer flange of the second pivot plug is equipped with a plurality of radially spaced tension adjustment apertures, which are sized to receive a biasing pin. All of the components comprising the hinge assembly, with the exception of the spring and bolts, may be stamped from structural sheet metal. Structural sheet metals include mild steel, stainless steel, brass, aluminum, titanium, copper, and alloys thereof. An optional feature is a semi-circular serrated adjustment wrench, a central pivot of which fits into a mounting screw hole on the base plate. When rotated about the pivot with the inner hinge component loosely attached to the base plate, the position of the inner hinge component can be easily and accurately adjusted, thereby facilitating the installation of the hinge on the gate and fence. The drawn ears on the outer hinge component are far stronger than the cantilevered ears of the hinges presently in use.

### BRIEF DESCRIPTION OF THE DRAWINGS

FIG. 1 is an isometric view of the prior art gate hinge of U.S. Pat. No. D443,196;

FIG. 2 is an exploded view of the new gate hinge assembly;

FIG. 3 is an assembled view of the new gate hinge assembly and an adjustment wrench;

FIG. 4 is an isometric bottom/side view of the semi-circular serrated adjustment wrench;

FIG. 5 is an isometric top/side view of the semi-circular serrated adjustment wrench;

FIG. 6A is an isometric see-through view of a first embodiment tripartite pivot pin assembly consisting of first and second pivot caps held together by a peened or swedged, stamped rivet;

FIG. 6B is an isometric see-through view of a second embodiment tripartite pivot pin assembly consisting of first and second pivot caps held together by a peened or swedged, cylindrical rivet;

FIG. 7 is an isometric front/bottom side view of the inner hinge component;

FIG. 8 is an isometric front/top side view of the inner hinge component;

FIG. 9 is an isometric rear/bottom side view of the inner hinge component;

FIG. 10 is a bottom side view of the inner hinge component;

FIG. 11 is a front side view of the inner hinge component;

FIG. 12 is a rear side view of the inner hinge component;

FIG. 13 is a front side view of the inner hinge component;

FIG. 14 is an isometric top view of the base plate;

FIG. 15 is an isometric bottom view of the base plate;

FIG. 16 is an isometric view of the coil spring;

FIG. 17 is an isometric view of the outer hinge component;

FIG. 18 is an isometric view of a laminar rivet as originally stamped;

FIG. 19 is an isometric view of a laminar rivet following peening or swedging;

FIG. 20A is an isometric top view of the first pivot plug plug;

FIG. 20B is an isometric bottom view of the first pivot plug;

FIG. 20C is an isometric top/side view of the first pivot plug;

FIG. 21A is an isometric top view of the second pivot plug;

FIG. 21B is an isometric bottom view of the second pivot plug; and

FIG. 21C is an isometric top/side view of the second pivot plug.

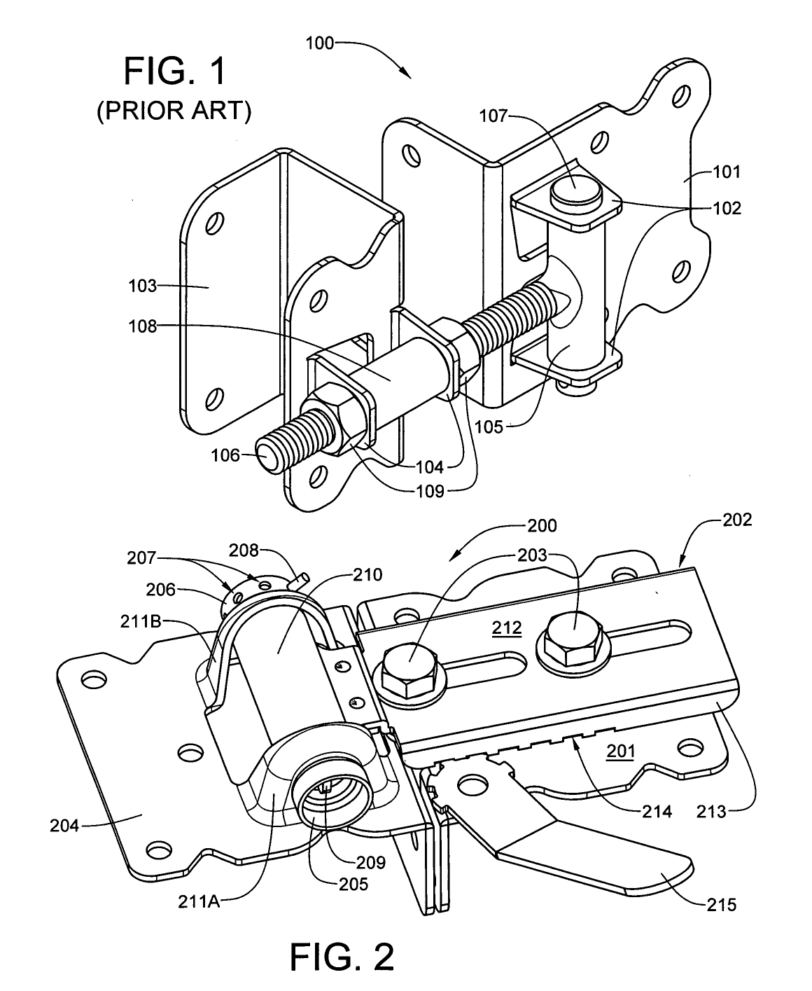

### PREFERRED EMBODIMENT OF THE INVENTION

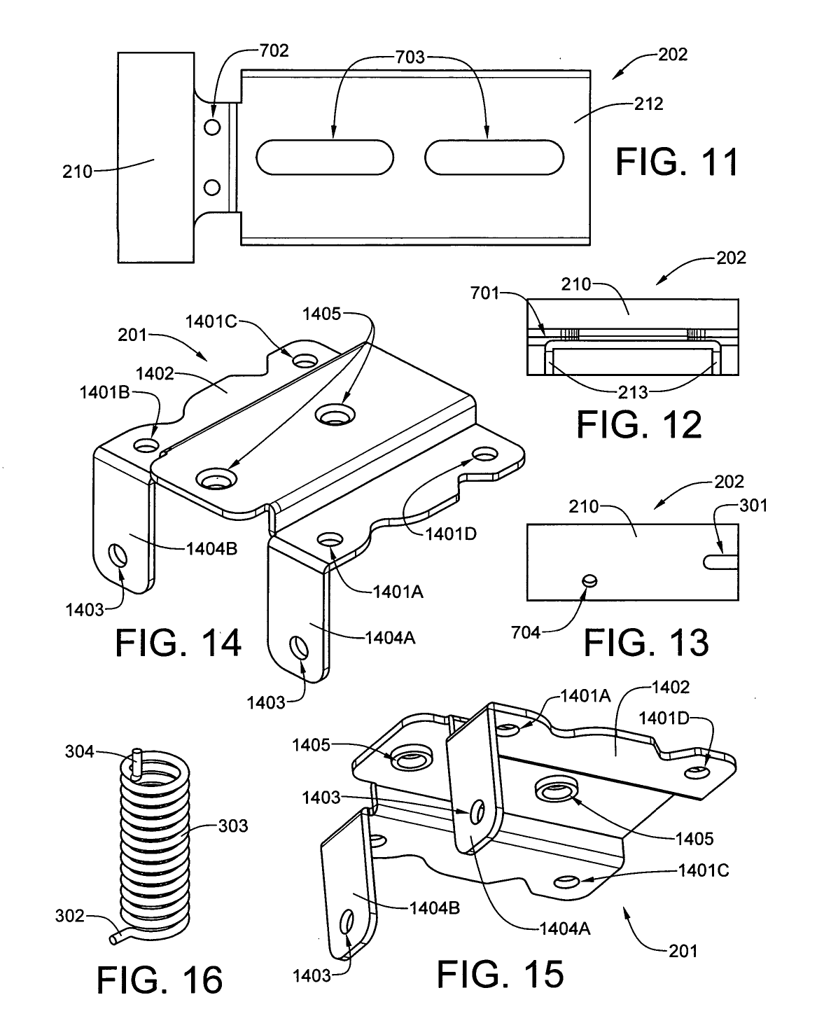

The new adjustable gate hinge assembly is both stronger and less expensive to manufacture than conventional gate hinges fabricated from sheet metal stampings and machined parts. Rather than using a pair of solid, machined pivot caps which are riveted together with a machined pin, the present invention uses a pair of stamped pivot caps held together with a peened or swedged rivet. This feature, alone, results in substantial cost savings in the fabrication of the new gate hinge assembly. In addition, by using a metal forming process which not only cuts and bends, but also draws the sheet metal, cantilevered pivot ears are eliminated by the new design. Moreover, the new gate hinge assembly eliminates the threaded adjustment rod in favor of a slidable shank that is bolted to a base plate. The new adjustable gate hinge will now be described with reference to the accompanying drawing FIGS. 2 through 21C.

Referring now to the exploded view of FIG. 2, a preferred embodiment of the new gate hinge assembly 200 comprises a base plate 201 mountable to a gate or door; an inner hinge component 202 slidably adjustable and securable to the base plate 201; an outer hinge component 203 mountable to a fence or wall; first and second pivot plugs (204 and 205, respectively), which, in combination with a rivet 206, rotatably secure the inner hinge component 202 within the outer hinge component 203; a coil spring 207 which, when loaded, makes the hinge assembly 200 either self-closing or self-opening; and a spring biasing pin 208 which is used to adjust the loading on the coil spring 207.

Still referring to FIG. 2, the outer hinge component 203 includes a pair of opposed ears 209A and 209 B, each of which incorporates a cylindrical aperture 210A and 210 B, respectively. Both cylindrical apertures 210A and 210B are axially aligned with respect to each other. During the stamping and drawing process which forms the outer hinge component 203, an assembly aperture 211 is formed between the opposed ears 209A and 209B. A portion of the metal removed from the assembly aperture 211 is drawn and shaped to form the opposed ears 209A and 209B. The inner hinge component 202 has both a tubular member 212, which pivotally mounts between the drawn ears 209A and 209B with minimum clearance (e.g. 0.001 to 0.005 inch), and a shank portion 213 integrally attached thereto, which is slidably adjustable with respect to and securable to the base plate 201 with at least one threaded fastener. Two threaded fasteners, in the form of machine-threaded cap bolts 214, are shown. Self-tapping bolts may also be used. The shank portion 213 of the inner hinge component 202 has a pair of opposed parallel longitudinal flanges 215 (only one is visible in this view), which are spaced to act as guides as the shank portion 213 slides on a raised portion 216 of the base plate 201. At least one of the longitudinal flanges 215 has a linear array of adjustment teeth 217, forming a rack gear, cut along the outer edge thereof. A hinge adjustment wrench 218, has a central pivot (not shown in this view) that fits within a mounting screw hole 219A in the base plate 201. The hinge adjustment wrench 218 has a semi-circular pinion gear 220 that meshes with the adjustment teeth 217, thereby permitting bidirectional movement and accurate positioning of the inner hinge component 202 on the base plate 201 before the cap bolts 214 are tightened to secure them together.

Still referring to FIG. 2, the tubular member 212 of the inner hinge component 202 is equipped with a slot 221, which receives an outwardly-bent first end 222 of the coil spring 207 which fits within the tubular member 212 of the inner hinge component 202. An opposite, or second end 223, of the coil spring 207 is bent so that it is parallel to the central axis of the spring. The second end 223 fits within a spring retention aperture 224 of the second pivot plug 205. It will be noted that the second pivot plug 205 incorporates multiple pairs of diametrically-opposed, axially-aligned, and radially-spaced spring adjustment apertures 225, which are sized to receive the spring biasing pin 208, one end of which is biasable against the outer hinge component 203. The spring tension adjustment apertures 225 are located in an outer flange 226 of the second pivot plug 205.

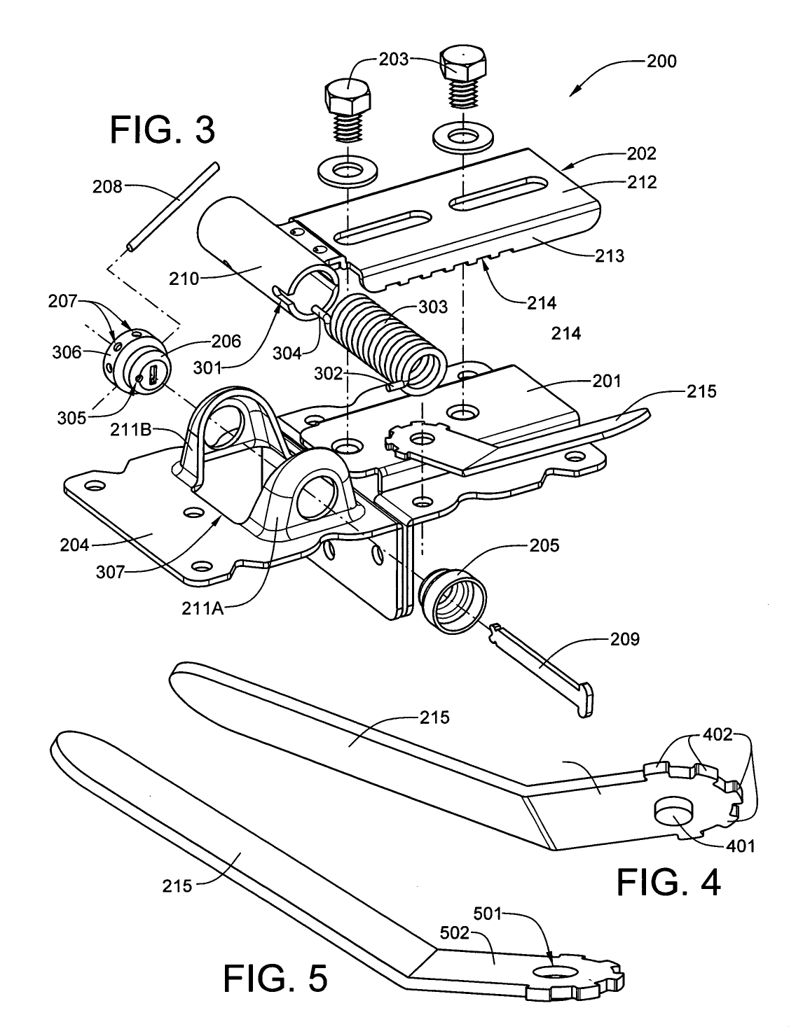

Referring now to FIGS. 2 and 3, the first and second pivot plugs 204 and 205, respectively, serve to locate the inner hinge component 202 within the outer hinge component 203. The rivet 206 is a stamped, laminar piece which has both a stamped head 227 and a deformable end 228. During assembly of the hinge assembly 200, the coil spring 207 is inserted within the tubular member 212 so that the first end 222 of the coil spring 207 engages the slot 221. The inner hinge component 202 is then inserted through the assembly aperture 211, shank portion 213 first. When the tubular member 212 passes through the assembly aperture 211, it is positioned so that it is axially aligned with the two cylindrical apertures 210A and 210B. The first pivot plug 204 is then inserted through the first cylindrical aperture 210A and into the slotted end of the tubular member 212, while the second pivot plug 205 is inserted through the second cylindrical aperture 210B and into the opposite end of the tubular member 212, with the spring retention aperture 224 of the second pivot plug 205 engaging the second end 223 of the coil spring 207. The rivet 206 is then inserted through a central aperture 229 in each pivot plug (only the central aperture 229 of the second pivot plug 205 is visible in this view). After the deformable end 228 is deformed through peening, swedging, or other similar process, the two pivot plugs 204 and 205 locked in place within their respectively associated cylindrical apertures 210A or 210B. The second pivot plug 205 is then rotated clockwise (looking at the head of rivet 206 within pivot plug 205) to make the hinge assembly 200 self-opening, or rotated counter-clockwise to make the hinge assembly 200 self-closing. The biasing pin 208 is then inserted through at least one spring adjustment aperture 225, with one end thereof biased against the outer hinge component 203, thereby rotationally locking the second pivot plug 205 in position and maintaining the loading on the coil spring 207. If the self-closing or self-opening feature is not required for the hinge assembly 200, the coil spring 207 may be eliminated therefrom. The completely assembled hinge assembly 300 is shown in FIG. 3.

Referring now to FIGS. 4 and 5, the hinge adjustment wrench 218 is shown in greater detail. For example, in FIG. 4, the pivot 401 on the lower surface 402 of the wrench 218 is clearly visible, as are the individual pinion teeth 403, which mesh with adjustment teeth 217 on the inner hinge component 202. In FIG. 5, it can be seen that the pivot 401 is formed by an incomplete punch process known as “coining”, which leaves an indentation 501 in the upper surface 502 of the serrated adjustment wrench 218.

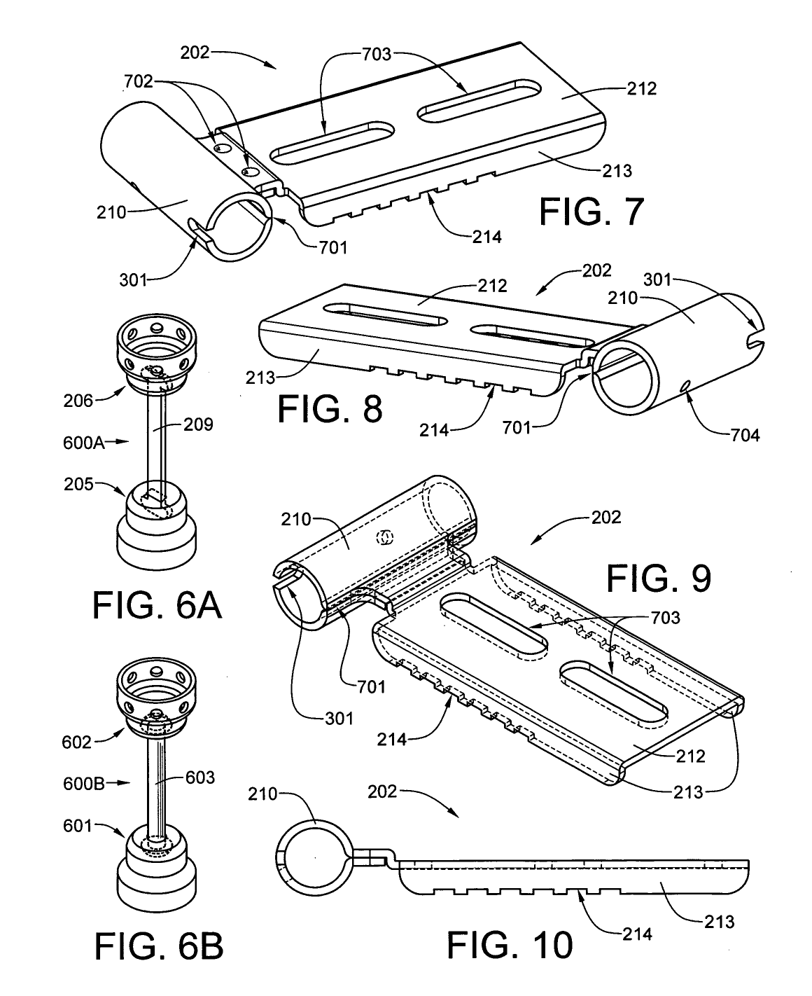

Referring now to FIG. 6A, a first embodiment tripartite pivot pin assembly 600A includes first and second pivot plugs 204 and 205, respectively, and a laminar stamped rivet 206, which have been assembled by peening or swedging the deformable end 228 of the stamped rivet 206. The assembly merely serves as a demonstrative device, as the assembly would normally be largely hidden from view if assembled in combination with the inner and outer hinge components 202 and 203, respectively.

Referring now to FIG. 6B, a second embodiment tripartite pivot pin assembly 600B first and second pivot plugs 601 and 602, respectively, and a cylindrical rivet 603, which have been assembled by deforming both ends of the cylindrical rivet 603 via peening or swedging. The central aperture 603 within each of the second embodiment first and second pivot plugs 601 and 602 are circular, instead of rectangular as in the first embodiment first and second pivot plugs 204 and 205. The assembly merely serves as a demonstrative device, as the assembly would normally be largely hidden from view if assembled in combination with the inner and outer hinge components 202 and 203, respectively.

Referring now to FIGS. 7 through 13, detail of the inner hinge component 202 can be more clearly seen. The entire part is formed from a single piece of sheet metal in a progressive stamping and rolling process. The tubular member 212 is formed during this progressive forming process, which may include as many as three steps. The tubular member 212 includes a seam 701, which is secured by at least two spot welds 702 where the rolled tubular member 212 reconnects with the shank portion 213. The inner hinge component 202 also includes a pair of elongated apertures 703, which permit adjustable positioning of the inner hinge component 202 on the base plate 201 (see FIGS. 2 or 3). Referring particularly to the see-through views of FIGS. 8 and 9, it will be noted that the shank portion 213 has a pair of downwardly-bent, opposed, parallel flanges 215, each of which is provided with a row of adjustment teeth 217. In most of the views of the inner hinge component 202, a spring securing aperture 704, used to hold the spring in place during assembly of the gate hinge assembly 200, is visible.

Referring now to FIGS. 14 and 15, details of the base plate 201 are more readily visible. This particular embodiment thereof has a first set of four mounting screw holes 219A, 219B, 219C and 219D on the upper portion 1401, and a second set of two mounting screw holes 1402, each of which is located on separate tabs 1403A and 1403B, that are continuous with and perpendicular to the upper portion 1401. Either mounting screw hole 219A or 219B may be used as a rotational seat for the pivot 401 of adjustment wrench 218. A pair of shank portion attachment holes 1404 may be threaded during manufacture, or may be threaded through the use of threaded fasteners such as the machine-threaded cap bolts 214 or self-tapping cap bolts.

Referring now to FIG. 16, another view of the coil spring is shown. Each of the elements thereof has been heretofore described.

Referring now to FIG. 17, details of the outer hinge component 203 are more clearly visible. The entire part is also formed from a single piece of sheet metal in a single stamping and forming process. The pair of drawn ears 209A and 209B are opposed and positioned on opposite sides of assembly aperture 211, which is sized to permit the shank portion 213 of the inner hinge component 202 to be inserted therethrough. Each of the drawn ears 209A and 209B includes an arch portion 1701 that transitions into an end portion 1702. Together, each arch portion 1701 and end portion 1702 pair transition into a front panel portion 1703. Each end portion is equipped with a pivot aperture 210A or 210B. The front panel portion 1703, together with a side panel portion 1704, form a right angle mounting bracket. The front panel portion 1703 incorporates three front mounting screw holes 1705 and the side panel portion 1705 incorporates two side mounting screw holes 1706. It will be noted that each arch portion 1701 has a predominantly concave inner surface 1707 and a predominantly convex outer surface 1708.

Referring now to FIG. 18, a laminar rivet 206 used to retain the first and second pivot plugs 204 and 205, respectively, in their respective pivot apertures 210A and 210B, is shown in an unpeened or unswedged (undeformed) state. Like most of the other components comprising the new gate hinge assembly 200, the rivet is stamped from sheet metal. It has a first stamped head 227 and a deformable head 228 sized to fit through the rectangular central aperture 229 of first and second pivot plugs 204 and 205.

Referring now to FIG. 19, the laminar rivet 206 of FIG. 18 is shown after being subjected to a head deforming operation using peening or swedging, which forms a deformed head 1901 that would lock the two pivot plugs 204 and 205 together, as shown in FIG. 6A.

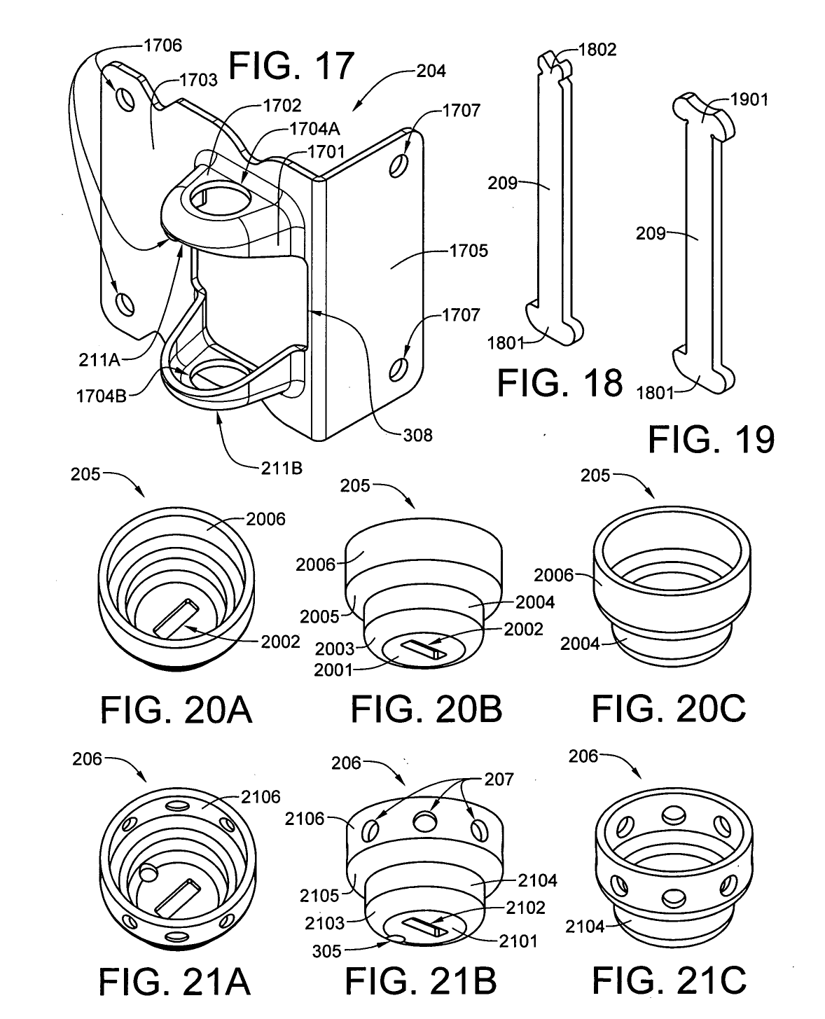

Referring now to FIGS. 20A, 20B and 20C, the first pivot plug 204 is shown in various views. It consists of a single stamping which provides a generally planar head portion 2001 having a rectangular slot 229 therein; a radiused shoulder portion 2003; a tubular retaining portion 2004 sized for a non-interference fit in pivot apertures 210A or 210B and the interior of tubular member 212 with generally minimum clearance within the range of about 0.001-0.005 inch; a radiused flanged portion 2005 which forms a retaining head for the first pivot plug; and an annular portion 2006, which bestows additional structural integrity on the first pivot plug 204.

Referring now to FIGS. 21A, 21B and 21C, the second pivot plug 205 is shown in various view. It also consists of a single stamping which provides a generally planar head portion 2101 having both a rectangular slot 229 and a spring retention aperture 224, which accepts the second end 223 of coil spring 207 a radiused shoulder portion 2103; a tubular retaining portion 2104 sized for a non-interference fit in pivot apertures 1704A or 1704B and the interior of tubular member 212 with generally minimum clearance within the range of about 0.001-0.005 inch; a radiused flanged portion 2105 which provides a retaining head for the second pivot plug 205; and an annular portion 2106 which not only rigidifies the second pivot plug 205, but also contains a plurality of radially spaced spring tension adjustment apertures 225 which are sized to receive the biasing pin 208. By rotating the second pivot plug 205, the coil spring 207 may be loaded to provide a self-closing or a self-opening hinge. With the biasing pin 208 passing through a pair of diametrically-opposed spring tension adjustment apertures 225 and an end thereof biased against the outer hinge component 203, the second pivot plug 205 is locked in position with respect to the outer hinge component 203, thereby maintaining the loading on the coil spring 207.

Although only a single embodiment of the new gate hinge assembly is disclosed herein, it will be obvious to those having ordinary skill in the art that changes and modifications may be made thereto without departing from the scope and the spirit of the invention as hereinafter claimed. For example, the assembly aperture 211 might be eliminated by drawing the opposed ears 209A and 209B from metal on the outer perimeter of the outer hinge component 203. However, the appearance of the final product would be less appealing and more metal would be required in the forming process. The assembly aperture 211 of the preferred embodiment is also required for assembly of the inner hinge component 202 between the opposed ears 209A and 209B of the outer hinge component 203 with acceptable levels of minimum clearance between the tubular member 212 and the opposed ears 209A and 209B.

1. A gate hinge assembly comprising:
a base plate mountable to a gate;
an outer hinge component mountable to a fence, said outer hinge component being formed from a single piece of structural sheet metal, and having a pair of opposed drawn ears, each ear generally in the shape of an arch a predominantly concave inner surface, a predominantly convex outer surface, and a cylindrical pivot aperture that is axially aligned with the pivot aperture of the other ear; and
an inner hinge component, said inner hinge component having a shank portion that is slidably adjustable with respect to and securable to the base plate, said inner hinge component also having a tubular member affixed to an end of said shank portion, said tubular member being both axially sized to fit between the inner surfaces of said drawn ears and hingeably coupled to said outer hinge component between said drawn ears.

2. The gate hinge assembly of claim 1, wherein said shank portion includes a flange equipped with a plurality of equally-spaced adjustment teeth; and said gate hinge assembly further comprises a wrench having a pivot insertable within a mounting screw aperture in said base plate, said wrench also having a plurality of serrations which, when said pivot is inserted within a mounting screw aperture, mesh with said adjustment teeth, so that when the wrench is rotated about said pivot, said inner hinge component is reversably movable with respect to said base plate.

3. The gate hinge assembly of claim 1, which further comprises first and second pivot plugs, each pivot plug having an annular pivot portion which fits through the pivot aperture of one drawn ear and enters an end of the tubular member, thereby axially aligning said tubular member with the pivot apertures; and
a rivet passing through said first and second pivot plugs, thereby securing them within their respectively associated pivot apertures and generally limiting movement of said inner hinge component, with respect to said outer hinge component, to rotational movement about an axis passing through the center of each pivot aperture.

4. The gate hinge assembly of claim 3, wherein each of the following elements of the assembly is formed from a single piece of sheet metal:
said base plate;
said inner hinge component; and
said first and second pivot plugs.

5. The gate hinge assembly of claim 1, wherein said outer hinge component includes an assembly aperture interposed between the pair of drawn opposed ears, and said shank portion is sized to pass through the assembly aperture.

6. The gate hinge assembly of claim 3, which further comprises means for biasing the assembly as self-closing or self-opening, said means for biasing comprising:
a coil spring positionable within said tubular member, a bent first end of said coil spring being securable within a slot cut within a first end of said tubular member, said slot being parallel to the axis of said tubular member, a bent second end of said coil spring being securable within a spring retention aperture within said second pivot plug; and
means for maintaining the loading on the coil spring after said second pivot plug has been axially rotated to load said coil spring, said means for maintaining the loading comprising a biasing pin inserted through at least one spring tension adjustment aperture in the collar of said second pivot plug, and bearing on the outer hinge component, thereby rotationally locking said second pivot plug with respect to the outer hinge component.

7. The gate hinge assembly of claim 1, wherein said tubular member is hingeably coupled to said outer hinge component between said drawn ears by a tripartite pivot pin comprising:
first and second pivot plugs, each pivot plug having an annular pivot portion which fits through the pivot aperture of one drawn ear and enters an end of the tubular member, thereby axially aligning said tubular member with the pivot apertures, each pivot plug also having a central aperture; and
a rivet passing through the central aperture of each of said first and second pivot plugs, said rivet being deformed on at least one end to secure said pivot plugs within their respectively associated pivot apertures.

8. The gate hinge assembly of claim 1, wherein the shank portion of said inner hinge component is secured to said base plate with at least one threaded fastener.

9. The gate hinge assembly of claim 8, wherein said at least one threaded fastener is selected from the group consisting of cap bolts and self-tapping cap bolts.

10. The gate hinge assembly of claim 7, wherein the central aperture of each pivot plug of rectangular cross section, and said rivet is a sheet metal stamping of generally rectangular cross section, having a stamped head at one end thereof and a deformed head at the opposite end thereof.

11. The gate hinge assembly of claim 7, wherein said rivet is a cylindrical pin, both ends of which have been deformed.

12. The gate hinge assembly of claim 1, wherein a single piece of sheet metal is stamped, rolled and welded to form said inner hinge component.

13. The gate hinge assembly of claim 1, wherein said base plate and said outer hinge component are each provided with a plurality of mounting screw apertures.

14. A gate hinge assembly comprising:
a base plate mountable to a gate;
an outer hinge component mountable to a fence, said outer hinge component formed from a single piece of structural sheet metal, and having a pair of opposed ears, each ear generally in the shape of an arch an having a predominantly concave inner surface, a predominantly convex outer surface, and a cylindrical pivot aperture that is axially aligned with the pivot aperture of the other ear; and
an inner hinge component, said inner hinge component formed from a single piece of stamped, rolled and welded sheet metal, and having a shank portion that is slidably adjustable with respect to and securable to the base plate, said inner hinge component also having a tubular member affixed to an end of said shank portion, said tubular member being both axially sized to fit between the inner surfaces of said ears and hingeably coupled to said outer hinge component between said ears.

15. The gate hinge assembly of claim 14, wherein said shank portion includes a flange equipped with a plurality of equally-spaced adjustment teeth; and said gate hinge assembly further comprises a wrench having a pivot insertable within a mounting screw aperture in said base plate, said wrench also having a plurality of serrations which, when said pivot is inserted within a mounting screw aperture, mesh with said adjustment teeth, so that when the wrench is rotated about said pivot, said inner hinge component is reversably movable with respect to said base plate.

16. The gate hinge assembly of claim 14, which further comprises first and second pivot plugs, each pivot plug having an annular pivot portion which fits through the pivot aperture of one ear and enters an end of the tubular member, thereby axially aligning said tubular member with the pivot apertures; and
a rivet passing through said first and second pivot plugs, thereby securing them within their respectively associated pivot apertures and generally limiting movement of said inner hinge component, with respect to said outer hinge component, to rotational movement about an axis passing through the center of each pivot aperture.

17. The gate hinge assembly of claim 14, wherein said outer hinge component includes an assembly aperture interposed between the pair of opposed ears, and said shank portion is sized to pass through the assembly aperture.

18. The gate hinge assembly of claim 16, which further comprises means for biasing the assembly as self-closing or self-opening, said means for biasing comprising:
a coil spring positionable within said tubular member, a bent first end of said coil spring being securable within a slot cut within a first end of said tubular member, said slot being parallel to the axis of said tubular member, a bent second end of said coil spring being securable within a spring retention aperture within said second pivot plug; and
means for maintaining the loading on the coil spring after said second pivot plug has been axially rotated to load said coil spring, said means for maintaining the loading comprising a biasing pin inserted through at least one spring tension adjustment aperture in the collar of said second pivot plug, and bearing on the outer hinge component, thereby rotationally locking said second pivot plug with respect to the outer hinge component.

19. The gate hinge assembly of claim 14, wherein said tubular member is hingeably coupled to said outer hinge component between said drawn ears by a tripartite pivot pin comprising:
first and second pivot plugs, each pivot plug having an annular pivot portion which fits through the pivot aperture of one ear and enters an end of the tubular member, thereby axially aligning said tubular member with the pivot apertures, each pivot plug also having a central aperture; and
a rivet passing through the central aperture of each of said first and second pivot plugs, said rivet being deformed on at least one end to secure said pivot plugs within their respectively associated pivot apertures.

20. The gate hinge assembly of claim 14, wherein the shank portion of said inner hinge component is secured to said base plate with at least one threaded fastener.
